(19) United States
(12) Patent Application Publication
(10) Pub. No.: US 2009/0185666 A1
(43) Pub. Date: Jul. 23, 2009

(54) METHOD, SYSTEM AND SERVER FOR TRACING SERVICES

(75) Inventors: Jie Tang, Shenzhen (CN); Xiaomin Shi, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/412,237

(22) Filed: Mar. 26, 2009

Related U.S. Application Data
(63) Continuation of application No. PCT/CN2008/070089, filed on Jan. 11, 2008.

(30) Foreign Application Priority Data
Apr. 9, 2007 (CN) 200710093750.8

(51) Int. Cl. H04M 3/22

(52) U.S. Cl. 379/32.05

(57) ABSTRACT

A method, system and device for tracing services are provided. The method includes includes: receiving a service tracing request message which carries information on the service to be traced and the callback information; tracing the service according to the information on the service to be traced and obtaining the feedback service tracing data; and sending the feedback service tracing data according to the callback information. Through the present invention, the service tracing data is fed back effectively in time after the service tracing requester sends a service tracing request.

The present application claims the priority of CN Application No. 200710093750.8 filed on Apr. 9, 2007, titled “METHOD, SYSTEM AND SERVER FOR TRACING SERVICES”, which is incorporated herein by reference in its entirety.

### FIELD OF THE INVENTION

The present invention relates to the field of communication technologies, and in particular, to a method and system for tracing service states, and a service tracing control server.

### BACKGROUND

With the development of the communication industry, it is necessary to solve the complaints lodged by users about service or application faults quickly in order to improve user satisfaction. Service tracing is an effective way of fault analyzing and locating. A tracing control system for managing and maintaining the service lifecycle and tracing services is put forward by the Open Mobile Alliance (OMA). In the OMA Service Provider Environment (OSPE), the parts related to service tracing are three modules: a tracing control server, a tracing agent, and a service database that is responsible for storing and maintaining the service catalogues and models. The tracing control server may be an OSPE server, and the service database may be a Service Model And Catalogue (SMAC).

FIG. 1 shows an OSPE system structure. As shown in FIG. 1, an OSPE system includes:

a service tracing requester, adapted to send a message of starting tracing to the OSPE, request a Service Level Tracing (SLT) task from the OSPE server, and obtain service tracing data from the OSPE server;

an OSPE server, adapted to: manage tracing activities, and more particularly, receive the command of starting and stopping tracing from the service tracing requester; send service tracing data to the service tracing requester; query the required service information from the SMAC; control the tracing agent to start and stop tracing; and receive the service tracing data from the tracing agent, where the service tracing data may include service tracing results;

a SMAC, adapted to store dependency relations of the service. By querying the SMAC, the OSPE server obtains service-related information;

a tracing agent, deployed on a service component and responsible for handling service tracing. The tracing agent is controlled by the OSPE server, and may receive control commands (starting, stopping) and report logs to the OSPE server;

an OSPE-2 interface, through which the service tracing requester sends a service tracing request (for example, activating a service tracing process, deactivating a service tracing process) to the OSPE server and requests the existing service tracing data;

an OSPE-3 interface, through which the OSPE server registers services and components to the SMAC and manages and maintains the data of relations between services and components; and

an OSPE-5 interface, through which the OSPE server delivers tracing tasks to the tracing agent, and receives the service tracing data returned from the tracing agent.

As shown in FIG. 2, the service tracing process of an OSPE system in the conventional technology includes the following steps:

Step 201: The service tracing requester sends a service tracing request to the OSPE server through the OSPE-2 interface, the request carrying tracing-related information such as the flag of the traced service.

Step 202: The OSPE server queries the SMAC server according to the service tracing request information, and queries the tracing-related services, components and dependency relations. (If the OSPE server has enough tracing-related information, this step and the next step may be skipped).

Step 203: The SMAC returns information on services and components to the OSPE server.

Step 204: The OSPE server starts the tracing agent on the relevant tracing component, delivers a tracing task, and is ready to collect service tracing data.

Step 205: The tracing agent performs service tracing.

Step 206: The tracing agent returns service tracing logs, namely an embodiment of the service tracing data, to the OSPE server.

Step 207: The OSPE server processes and stores the service tracing data and waits for being requested.

Step 208: The service tracing requester requests service tracing logs from the OSPE server.

Step 209: The OSPE server returns service tracing logs to the service tracing requester.

According to the service tracing method in the conventional technology, the obtained service tracing data is processed and stored by the OSPE server, and the OSPE server waits for a request message from the service tracing requester about obtaining the service tracing data. In this way, the service tracing requester is not able to obtain service tracing data effectively in time.

### SUMMARY

The embodiments of the present invention provides a method, system, and apparatus for tracing services to overcome the inability of the service tracing requester obtaining the service tracing data effectively in time in the conventional technology.

A service tracing method provided in an embodiment of the present invention includes: receiving a service tracing request message which carries the information on the service to be traced and the callback information; tracing the service according to the information on the service to be traced, and obtaining the feedback service tracing data; and sending the feedback service tracing data according to the callback information.

A service tracing system provided in an embodiment of the present invention includes: a tracing control server, adapted to trace a service according to the information on the service to be traced, and obtain the feedback service tracing data; a triggering module, adapted to trigger the tracing control server to trace the service after receiving the service tracing request message which carries the information on the service to be traced and the callback information; and a sending module, adapted to send the service tracing data which is fed back to the tracing control server according to the callback information.

A tracing control server for tracing services provided in an embodiment of the present invention includes: a receiving module, adapted to receive a service tracing request message which carries the information on the service to be traced and the callback information; a tracing control module, adapted to trace the service according to the information on the service to be traced, and obtain the feedback service tracing data; and a sending module, adapted to send the feedback service tracing data according to the callback information.

The embodiments of the invention bring the following benefits: The service tracing request message that triggers the service tracing includes the information on the service to be traced and the callback information. The feedback service tracing data is sent to the service tracing requester according to the callback information after the feedback service tracing data is received, without waiting for the service tracing requester to request the service tracing data. Therefore, the service tracing data can be fed back to the service tracing requester effectively in time.

### BRIEF DESCRIPTION OF THE DRAWINGS

FIG. 1 shows a structure of an OSPE system in the conventional technology;

FIG. 2 is a flowchart of a service tracing method implemented by an OSPE system in the conventional technology;

FIG. 3 is a flowchart of a service tracing method in an embodiment of the present invention;

FIG. 4 shows a structure of an OSPE system in an embodiment of the present invention;

FIG. 5 shows a structure of an OSPE server in an embodiment of the present invention;

FIG. 6 shows a service tracing process handled by an OSPE server in an embodiment of the present invention;

FIG. 7 shows a network structure for an OSPE system to implement service tracing in an embodiment of the present invention;

FIG. 8 shows a service tracing process implemented by an OSPE system in an embodiment of the present invention;

FIG. 9 shows a service tracing process implemented in an embodiment of the present invention;

FIG. 10 shows a Session Initiation Protocol (SIP) information data structure in the service tracing process implemented in an embodiment of the present invention; and

FIG. 11 shows a Simple Object Access Protocol (SOAP) information data structure in the service tracing process implemented in an embodiment of the present invention.

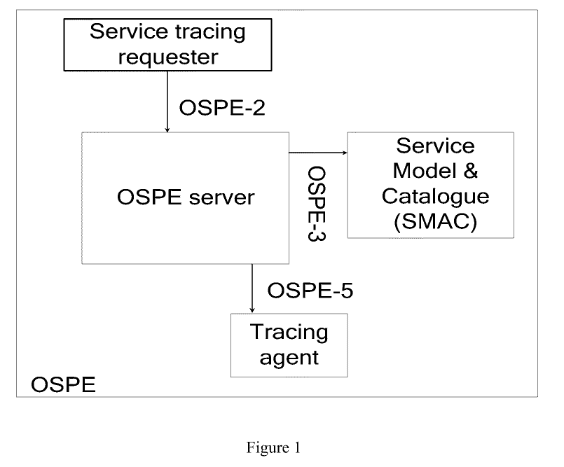

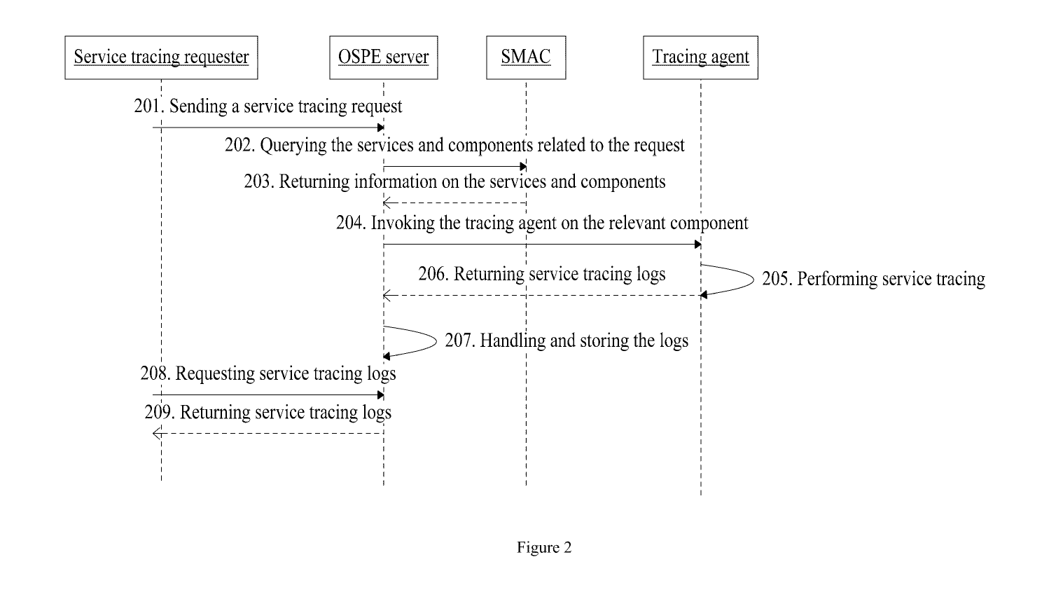

### DETAILED DESCRIPTION OF THE INVENTION

The invention is hereinafter described in detail by reference to embodiments and accompanying drawings.

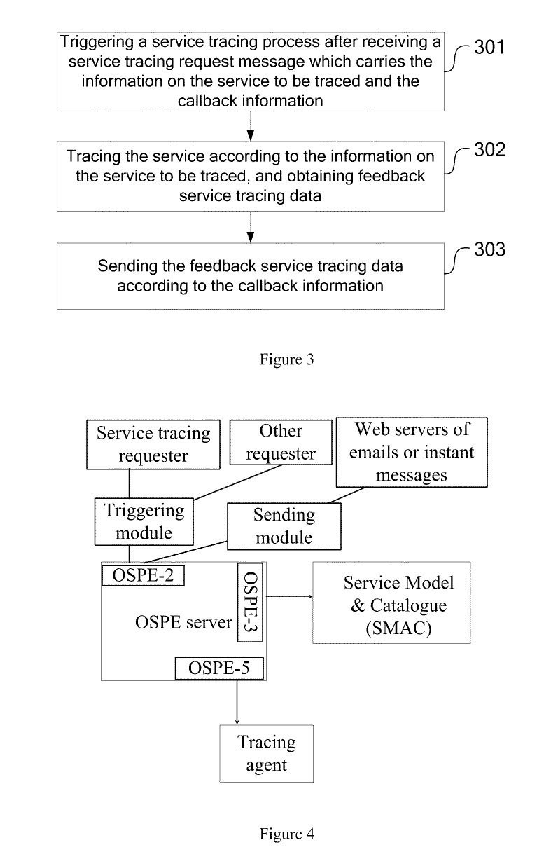

As shown in FIG. 3, a service tracing process implemented in an embodiment of the present invention includes the following steps:

Step 301: A service tracing process is triggered after receiving a service tracing request message which carries the information on the service to be traced and the callback information.

Step 302: The service is traced according to the information on the service to be traced, and the feedback service tracing data is obtained.

Step 303: The feedback service tracing data is sent according to the callback information.

The service tracing data is fed back according to the callback information, which overcomes the defect of the polling mechanism in the conventional, namely, the service tracing requester has to send a request message to request the service tracing data, and saves numerous resources consumed by the polling mechanism.

In order to obtain service tracing data for the service tracing requester timely in many ways, a callback method is used herein to overcome the inability of the service tracing requester obtaining the service tracing data effectively in time.

In practice, the callback information may include address information (indicating the callback address), namely, the service tracing data obtained from service tracing is sent according to the address information in the callback information. The address information includes but is not limited to Uniform Resource Locator (URL) information. In practice, the URL may be supported by the application device (for example, OSPE server). The entity capable of receiving the feedback service tracing data is not only the service tracing requester that sends the service tracing requester, but also other functional entities that support a URL. Therefore, the embodiment overcomes the defect of the unitary way of obtaining the service tracing data in the conventional technology.

Preferably, the callback information may also include information of sending policy, namely, the service tracing data is sent according to policy information. The information of sending policy may be constructed according to one item of or combination of: interval length of sending the service tracing data, data size of sending the service tracing data, level of detail of sending the service tracing data, and triggering event of sending the service tracing data.

Preferably, the callback information may further include protocol type information. The service tracing data is sent through interaction according to the protocol specified by the protocol type information.

In practice, a callback method may be added into the invocation modes of the OSPE-2 interface, thus adding processing of the callback information and reporting the service tracing data timely in many ways.

The service tracing request message parameter transferred through this interface may be implemented in various formats such as Extensible Markup Language (XML) format. As revealed in the embodiment, the service tracing request message aims to include, without being limited to, the information on the service to be traced and the callback information, and its format is not limited to the XML format illustrated in this embodiment. Taking the XML format as an example, the implementation is as follows:

<Command>Active</Command>
<.../>
<Callback protocolType=“soap” address=“http://huawei/callback”>
<Size>1000</Size>
</Callback>
<...>

Preferably, in the message parameter in the XML format in the above example, the callback-related information may include any combination of:

Address Information: adapted to specify the callback address(es) to which the service tracing data is sent. The callback address here may be a standard World Wide Web address such as http://huawei/callback in the foregoing example, or a SIP address such as sip:Callback Huawei, or other URL addresses supported by the application device;

Protocol Type Information: adapted to specify the protocol type expected to be used by the service tracing system (for example, OSPE system) to send the service tracing data. The protocol type may be SIP, WEB or other protocol types; and

Policy Information: adapted to decide the circumstances and modes in which the obtained service tracing data is sent to the foregoing callback address. The policy information may be, without being limited to, one item of or combination of the following policies:

Interval Length (the “Time” field): specifying the interval of sending service tracing data to the foregoing callback address;

Data Size (the “Size” field): specifying the size of the service tracing data to be sent to the foregoing callback address at a time;

Triggering Event (the “Special Event” field): specifying that the service tracing data is sent to the foregoing callback address only after the event specified in the triggering event collection occurs; and

Message Level (the “Information Level” field): specifying the level of detail of the service tracing data, for example, the service tracing data of a higher level is more detailed, and the higher level of detail indicates a larger size of the message that consumes more resources. The resource consumption may be reduced by setting the message level.

A service tracing system is provided in an embodiment of the present invention. The implementation mode of the system is described below by reference to accompanying drawings.

FIG. 4 shows a structure of an OSPE system in an embodiment of the present invention. As shown in FIG. 4, the service tracing system includes: a service tracing requester, other requesters, web server of emails or instant messages, OSPE server, triggering module, and sending module.

After receiving the service tracing request message that carries the information on the service to be traced and the callback information, the triggering module triggers the OSPE server to trace the services. The service tracing request message may be sent by the service tracing requester, or by other requesters, or by web servers of emails or instant messages.

The OSPE server traces the service according to the information on the service to be traced, and receives the feedback service tracing data.

According to the callback information, the sending module sends the service tracing data which is fed back to the OSPE server.

In practice, the callback information may include address information, and the sending module may include an address judging unit and a sending unit. The address judging unit is adapted to judge the address information in the callback information. The sending unit is adapted to send the service tracing data which is fed back to the OSPE server according to the address information in the callback information determined by the address judging unit. More particularly, when the service tracing requester or another requester sends a service tracing request message, the service tracing request message may be sent according to the address information in the callback information, where the address information indicates the address of the service tracing requester or other requesters.

Preferably, the callback information may further include information of sending policy, and the sending module may further include a policy judging unit. The policy judging unit is adapted to judge the information of sending policy in the callback information, and the sending unit may send the service tracing data which is fed back to the OSPE server according to the information of sending policy in the callback information determined by the policy judging unit.

Preferably, the callback information may further include protocol type information, and the sending module may further include a protocol judging unit, which is adapted to judge the protocol type information in the callback information. The sending unit may send the service tracing data according to the protocol specified by the protocol type information in the callback information.

A tracing control server for tracing services is provided in an embodiment of the present invention. The implementation mode of the server is described below by reference to accompanying drawings.

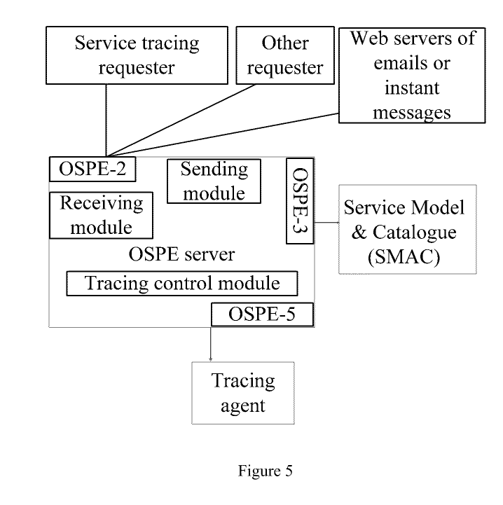

FIG. 5 shows a structure of an OSPE server in an embodiment of the present invention. As shown in FIG. 5, the OSPE server exists in the OSPE system and includes:

a receiving module, adapted to receive a service tracing request message which carries the information on the service to be traced and the callback information;

a tracing control module, adapted to trace the service according to the information on the service to be traced, and receive the feedback service tracing data; and

a sending module, adapted to send the feedback service tracing data according to the callback information.

In practice, the callback information may include address information, and the sending module may include an address judging unit and a sending unit. The address judging unit is adapted to judge the address information in the callback information. The sending unit is adapted to send the feedback service tracing data according to the address information in the callback information determined by the address judging unit.

Preferably, the callback information may further include information of sending policy, and the sending module may further include a policy judging unit. The policy judging unit is adapted to judge the information of sending policy in the callback information, and the sending unit may send the feedback service tracing data according to the information of sending policy in the callback information determined by the policy judging unit.

Preferably, the callback information may further include protocol type information, and the sending module may further include a protocol judging unit, which is adapted to judge the protocol type information in the callback information. The sending unit may send the service tracing data according to the protocol specified by the protocol type information in the callback information.

In practice, the sending module is responsible for sending the service tracing data to the callback address indicated by the address information. If the callback information specifies the protocol type, when determining that the protocol type is supported for processing, the sending module sends the service tracing data to the callback address indicated by the address information through interaction according to the protocol specified by the protocol type; or encapsulates the final message in this protocol format according to the protocol requirements, and sends the message to the callback address.

The policy judging unit is responsible for processing callback policies. For example, if the call policy specifies that the tracing data is sent only after the size of the tracing data reaches 1000, the policy judging unit checks whether the size of the collected tracing data meets the condition. Alternatively, the policy judging unit judges whether the callback address is valid according to the policy, for example, judges whether the address is an address format identifiable by the OSPE system that includes the OSPE server, and whether the address is physically reachable.

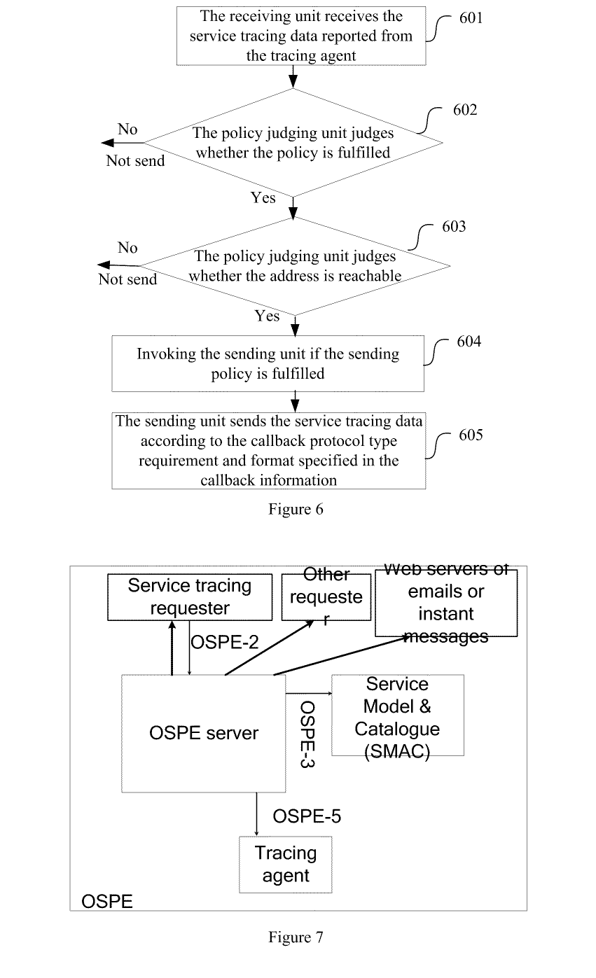

FIG. 6 shows a service tracing process handled by an OSPE server in an embodiment of the present invention. As shown in FIG. 6, the process includes the following steps:

Step 601: The receiving unit of the OSPE server receives the service tracing data reported by the tracing agent.

Step 602: The policy judging unit of the OSPE server judges the callback policy according to the callback information, for example, judges whether a callback policy exists and/or whether the condition specified in the callback policy is fulfilled such as whether the currently accumulated service tracing data reaches the size required by the callback policy. The policy judging unit returns a processing result. If the callback policy is fulfilled, the process goes to the next step; otherwise, the policy judging unit waits for the tracing agent to report the service tracing data next time, or waits for occurrence of a special event (for example, after a timer is set, the service tracing data is sent according to the timing policy).

Step 603: The policy judging unit judges whether the callback address in the policy is reachable, for example, whether the address complies with the type specified in the callback protocol type, whether the address is physically reachable. If the destination is reachable, the process proceeds to the next step; otherwise, the policy judging unit waits for the tracing agent to report the service tracing data next time, or makes a judgment again after a time interval.

Step 604: After the sending policy is fulfilled, the sending unit of the OSPE server is invoked.

Step 605: The sending unit sends the service tracing data according to the protocol type requirements and format specified in the callback information. If no protocol type is specified, the service tracing data is encapsulated in the default protocol format and sent, and particularly, the callback address may be filled into the service tracing data. The sending unit sends the encapsulated service tracing data to the network location or network device corresponding to the callback address, and notifies the interface for sending service tracing data (for example, OSPE-2 interface) to send the data.

Further description is given below, taking the service tracing based on an OSPE server as an example. The foregoing embodiment reveals that the network entities capable of tracing services are not limited to the OSPE server. Any functional entity can serve as another embodiment of the present invention if the function entity is capable of identifying the callback information in the service tracing request message, triggering the service tracing after receiving a service tracing request message, obtaining the service tracing data fed back by the tracing agent, and sending service tracing data according to the callback information. Although the OSPE server is taken as an example in this embodiment, the present invention is not limited to the OSPE server.

FIG. 7 shows a network structure for an OSPE system to implement service tracing in an embodiment of the present invention. As shown in FIG. 7, the network includes:

a service tracing requester with the foregoing relevant functions, an OSPE server, a SMAC, a tracing agent, relevant interfaces;

other requesters: other network modules with the same functions of a service tracing requester; and

web servers of emails or instant messages: web servers with a specific URL (for example, SIP address, web address).

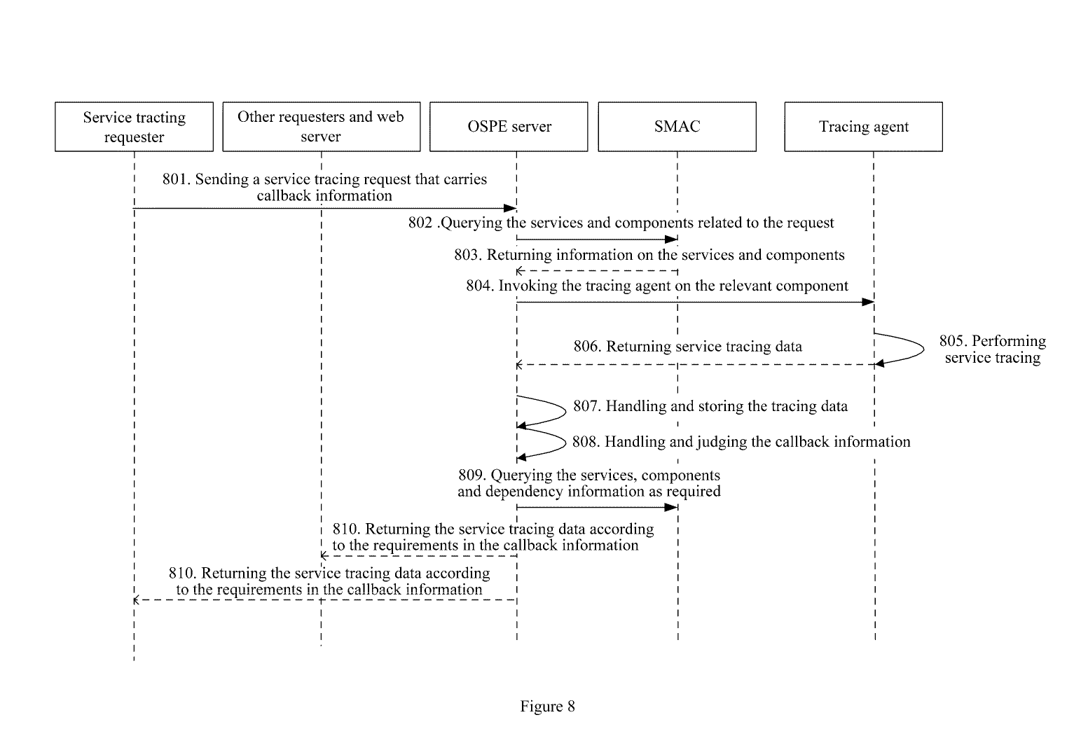

FIG. 8 shows a service tracing process implemented by an OSPE server in an embodiment of the present invention. As shown in FIG. 8, the process includes the following steps:

Step 801: The service tracing requester sends a service tracing request message to the OSPE server through the OSPE-2 interface, the request message carrying tracing-related information such as the information on the service to be traced and the callback information.

Step 802: The OSPE server queries the SMAC server according to the information on the service to be traced in the service tracing request information, and queries the tracing-related services, components and dependency relations. In practice, if the OSPE server has enough tracing-related information, steps 802 and 803 may be skipped).

Step 803: The SMAC returns the requested information.

Step 804: The OSPE server starts the tracing agent on the relevant service component, delivers a tracing task, and is ready to collect tracing data.

Step 805: The tracing agent performs the tracing task.

Step 806: The tracing agent reports the service tracing data to the OSPE server.

Step 807: The OSPE server processes and stores the service tracing data.

Step 808: The OSPE server processes and judges the callback information, for example, judges whether the policy in the callback information is fulfilled, whether the address in the callback information is reachable.

Step 809: When processing the callback information, if the OSPE server needs to obtain the services, components and independency relations thereof, the OSPE server may query the SMAC about such information.

Step 810: When the OSPE server determines that the policy in the callback information is fulfilled and the address in the callback information is reachable, the OSPE server sends the tracing data to the callback address specified in the callback information. In practice, the callback address may be the address of the service tracing requester, the address of other requesters, or the address of the web servers of emails/instant messages, depending on the callback information.

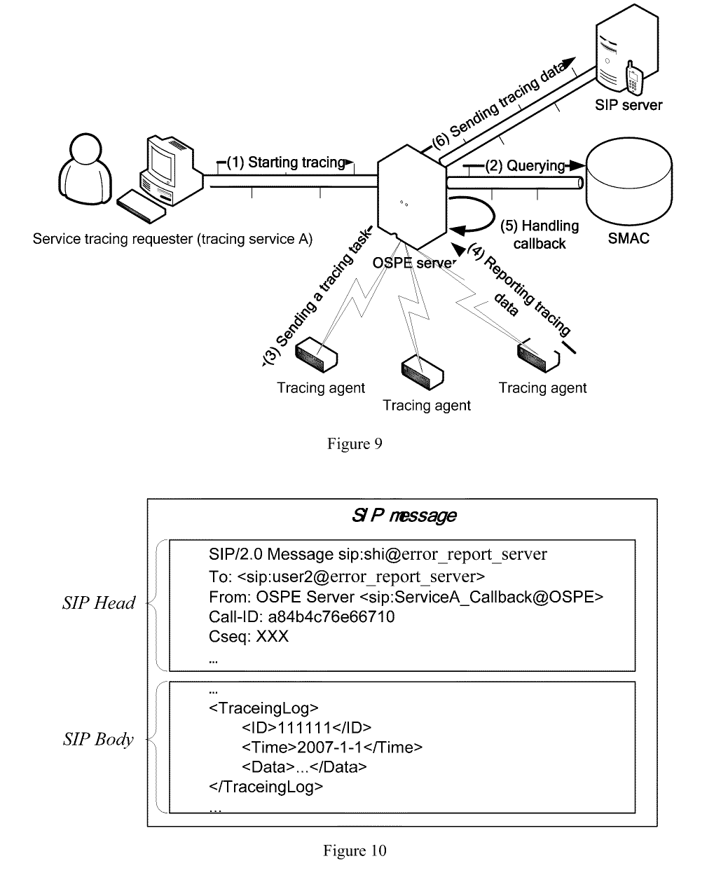

FIG. 9 shows a service tracing process implemented in an embodiment of the present invention. As shown in FIG. 9, the service tracing network includes a service tracing requester that requests to trace service A, an OSPE service, a SMAC, a tracing agent, and a SIP server.

1. Relation between the service tracing requester and the OSPE server

The primary user (service tracing requester) as a service provider needs to judge whether service A registered by the primary user on the OSPE server works normally, and requires the obtained tracing data of service A to be sent to the SIP server created by the secondary user as a network service maintainer on the network in time. Therefore, the primary user may log into his/her computer, and send a service tracing request to the OSPE server according to the format of the OSPE-2 interface. This embodiment is described below, taking the XML format as an example:

<Command>Active</Command>
<.../>
<Callback protocolType=“sip”
address=“sip:user2@error_report_server”>
<Time unit=“second”>1000</Time>
<Size unit=“kilobyte”>2</Size>
<SpecialEvent>NULL</SpecialEvent>
<InformationLevel>1</InformationLevel>
</Callback>
<...>

where the <Callback protocolType=“sip” address=“sip:user2@error_report_server”> indicates the address to which the service tracing data is sent, namely, the address of the SIP server created by the secondary user on the network, that is, user2@error_report_server.

2. After receiving the request, the OSPE server starts executing the service tracing task. The “Active” field indicates one tracing operation activated, and waiting for each tracing agent to report the service tracing data to the OSPE server. The implementation is described below, taking the XML format as an example:

<TraceingLog>
<ID>111111</ID>
<Time>2007-1-1</Time>
<Data>...</Data>
</TraceingLog>

3. After the tracing agent reports the service tracing data to the OSPE server, the OSPE server judges and processes the callback information, and may implement the following process:

(a) The OSPE server processes the callback information. Because the callback information includes the callback policy information, the OSPE server invokes the policy judging unit to judge the policy and check whether the policy fulfills the special event (for example, the “SpecialEvent” field), whether the size of the tracing data (for example, the “Size” field is fulfilled), and whether the sending interval (for example, the “Time” field) is fulfilled. If one item of or a combination of such check items is fulfilled, the process proceeds to the next step; otherwise, the OSPE server keeps waiting for the tracing agent to report the service tracing data.

(b) The OSPE server judges whether the callback address in the callback information is reachable, for example, judges whether the given callback address matches the given protocol type (for instance, the given protocol type is “Web”, but the given callback address is a SIP protocol address, which does not match), or judges whether the callback address is reachable first through a network probe method.

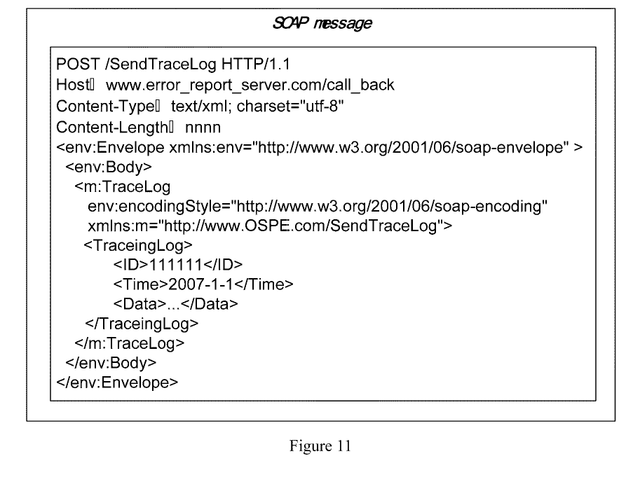

(c) The OSPE server sends the service tracing data according to the protocol type in the callback information. In this embodiment, suppose that the service tracing data is sent after being encapsulated, when the protocol type is “SIP”, the data is encapsulated into a SIP information data structure shown in FIG. 10. As shown in FIG. 10, in practice, the callback address may be filled into the message header field of the SIP information data structure, and the service tracing data may be filled into the message body of the SIP information data structure.

If the specified protocol type is Simple Object Access Protocol (SOAP), the data is encapsulated into a SOAP information data structure shown in FIG. 11.

4. The OSPE server sends the encapsulated service tracing data to the call address (for example, sip:user2@error_report_server) specified in the callback information. In this way, once the OSPE server collects the service tracing data that meets the callback condition, the OSPE server sends the service tracing data to the SIP server of the secondary user in the SIP format, without requiring the primary user to keep polling for sending the service tracing data.

The foregoing embodiment reveals that the service tracing data is sent according to the callback information, which overcomes the defect of the polling mechanism in the prior art, namely, the service tracing requester has to request the service tracing data through polling, and saves numerous resources consumed by the polling mechanism.

The entities capable of receiving feedback service tracing data are not limited to the service tracing requester that sends the service tracing request, and may be any other functional entity that supports URL. Therefore, the present invention overcomes the defect of unitary means of obtaining the service tracing data in the conventional technology.

In the conventional technology, after the service tracing requester sends a service tracing request message, a long link needs to be sustained for receiving the service tracing message, which requires sustention of the sequence of the interaction messages in the link and requires ceaseless polling for obtaining the service tracing data. By specifying a callback address, the embodiments of the present invention obtain the service tracing data without sustaining the long link.

In the conventional technology, no policy is applied. Therefore, all data received by the service tracing requester is the service tracing data for the current service tracing. However, the “return as requested” mechanism may lead to lack of logical relation between the service tracing request and the returned service tracing data. That is, the returned service tracing data may lack the complete logical meaning. For example, for a “name”, it is possible that only “na” is returned. Consequently, the service tracing requester has to keep polling and obtaining the complete data, and has to organize the data internally to obtain the complete message. The embodiments of the present invention customizes policies to specify the way of returning the service tracing data, and therefore, the complete service tracing data is sent. For example, the data is returned to the service tracing requester only after the data has a certain logical meaning. As a result, the service tracing requester does not need to consider the logical relation between the service tracing request message and the service tracing data, or consider the integrity of the service tracing data.

The embodiments of the present invention enable the service tracing requester to obtain the service tracing data in time, and the service tracing data may be obtained by multiple means (for example, emails, instant messages) and in multiple modes (for example, sent to the third party, based on the predefined policy) without affecting network performance.

The embodiments described above are only exemplary embodiments that are not intended to limit the protection scope of the present invention. The invention is intended to cover the modifications and variations provided that they fall in the scope of protection defined by the following claims or their equivalents.

1. A service tracing method, comprising:
receiving a service tracing request message which carries information on a service to be traced and callback information;
tracing the service according to the information on the service to be traced;
obtaining feedback service tracing data; and
sending the feedback service tracing data according to the callback information.

2. The method according to claim 1, wherein the callback information comprises address information, and the process of sending the feedback service tracing data according to the callback information is:
sending the feedback service tracing data according to the address information in the callback information.

3. The method according to claim 2, wherein the address information is Uniform Resource Locator (URL) address information.

4. The method according to claim 2, wherein the callback information further comprises information of sending policy, and the process of sending the feedback service tracing data according to the callback information is:
sending the feedback service tracing data according to the address information and the information of sending policy in the callback information.

5. The method according to claim 4, wherein:
the information of sending policy is constructed according to one item of or any combination of: interval length of sending the feedback service tracing data, data size of sending the service tracing data, level of detail of sending the service tracing data, and triggering event of sending the service tracing data.

6. The method according to claim 2, wherein the callback information further comprises protocol type information, and the process of sending the feedback service tracing data according to the callback information is:
sending the feedback service tracing data according to the address information in the callback information and a protocol specified in the protocol type information.

7. The method according to claim 1, wherein the detailed process of performing service tracing according to the information on the service to be traced and obtaining the feedback service tracing data is:
a tracing control server traces the service according to the information on the service to be traced, and obtains the feedback service tracing data.

8. A service tracing system, comprising:
a tracing control server, adapted to trace a service according to information on the service to be traced, and obtain feedback service tracing data;
a triggering module, adapted to trigger the tracing control server to trace the service after receiving a service tracing request message which carries the information on the service to be traced and callback information; and
a sending module, adapted to send service tracing data which is fed back to the tracing control server according to the callback information.

9. The system according to claim 8, wherein the callback information comprises address information, and the sending module comprises:
an address judging unit, adapted to judge the address information in the callback information; and
a sending unit, adapted to send the service tracing data which is fed back to the tracing control server according to the address information in the callback information determined by the address judging unit.

10. The system according to claim 9, wherein the callback information further comprises information of sending policy, and the sending module further comprises:
a policy judging unit, adapted to judge the information of sending policy in the callback information, and the sending unit is further adapted to send the service tracing data which is fed back to the tracing control server according to the address information and the information of sending policy in the callback information determined by the policy judging unit.

11. The system according to claim 9, wherein the callback information further comprises protocol type information, and the sending module further comprises:
a protocol judging unit, adapted to judge the protocol type information in the callback information; and
the sending unit is further adapted to send the service tracing data which is fed back to the tracing control server according to the address information and a protocol specified in the protocol type information determined by the protocol judging unit.

12. A tracing control server for tracing a service, comprising:
a receiving module, adapted to receive a service tracing request message which carries information on a service to be traced and callback information;
a tracing control module, adapted to trace a service according to the information on the service to be traced, and obtain feedback service tracing data; and
a sending module, adapted to send the feedback service tracing data according to the callback information.

13. The tracing control server according to claim 12, wherein the callback information comprises address information, and the sending module comprises:
an address judging unit, adapted to judge the address information in the callback information;
a sending unit, adapted to send the feedback service tracing data according to the address information in the callback information determined by the address judging unit.

14. The tracing control server according to claim 13, wherein the callback information further comprises information of sending policy, and the sending module further comprises:
a policy judging unit, adapted to judge the information of sending policy in the callback information, and the sending unit is further adapted to send the feedback service tracing data according to the address information and the information of sending policy in the callback information determined by the policy judging unit.

15. The tracing control server according to claim 13, wherein the callback information further comprises protocol type information, and the sending module further comprises:
a protocol judging unit, adapted to judge the protocol type information in the callback information; and
the sending unit is further adapted to send the feedback service tracing data according to the address information and a protocol specified in the protocol type information determined by the protocol judging unit.

16. A service tracing requesting method, comprising:
sending a service tracing request message which carries information on a service to be traced and callback information;
receiving feedback service tracing data according to the callback information, wherein the service is traced and the tracing data is obtained according to the callback information on the service.

17. The method according to claim 16, wherein the callback information comprises address information, and receiving of the feedback service tracing data according to the callback information is:
receiving the feedback service tracing data according to the address information in the callback information.

18. The method according to claim 17, wherein the callback information is a callback address of a Session Initiation Protocol (SIP), and the callback address is encapsulated into SIP information data.
